(19) United States
(12) Patent Application Publication
(10) Pub. No.: US 2006/0087975 A1
(43) Pub. Date: Apr. 27, 2006

(54) Methods and systems for providing redundancy protection in a Y-cable-based signal transmitter arrangement

(75) Inventors: Ping Zheng, Allen, TX (US); Xu Wang, Plano, TX (US)

Correspondence Address: JENKINS, WILSON & TAYLOR, P. A., 3100 TOWER BLVD, SUITE 1200, DURHAM, NC, 27707, US

(73) Assignee: Santera Systems, Incorporated

(21) Appl. No.: 10/991,686

(22) Filed: Nov. 18, 2004

Related U.S. Application Data
(60) Provisional application No. 60/616,651, filed on Oct. 7, 2004.

(51) Int. Cl. H04L 12/26

(52) U.S. Cl. 370/241

(57) ABSTRACT

Systems and methods for providing redundancy protection in a Y-cable-based signal transmitter arrangement having at least one first transmitter operating in an active mode and a second transmitter operating in a standby mode, wherein operating in the active mode includes transmitting data to a remote endpoint via a Y cable and a transmit interface, are disclosed. Data transmitted by the first transmitter to a remote endpoint is monitored for a loss of signal condition. Communications from the remote endpoint is monitored for a transmit failure indication. A determination is made as to whether to switch the second transmitter to the active mode based on a combination of the loss of signal and the transmit failure indication. In an alternative implementation, data transmitted by the first transmitter is not monitored and the decision to switch the second transmitter to the active mode is based primarily on transmit failure indications alone.

### RELATED APPLICATIONS

This application claims the benefit of U.S. Provisional Application No. 60/616,651 entitled “Media Gateway Features”, filed Oct. 7, 2004, the disclosure of which is incorporated herein by reference in its entirety.

### TECHNICAL FIELD

The subject matter described herein relates to providing redundancy protection in signal transmission system. More particularly, the subject matter described herein relates to providing redundancy protection in a Y-cable-based signal transmitter arrangement.

### BACKGROUND

In telecommunications switches, Y cables are used to connect active and standby transmitters and receivers to a common I/O cable. FIG. 1 illustrates a conventional Y cable 50. In FIG. 1A, Y cable 50 includes the first connector 52 with transmit and receive pins, a second connector 54 with transmit and receive pins, an active-side cable 56, a standby-side cable 58, a junction 60, and a common cable 62. In a typical application, connector 52 is connected to an active telecommunications switching module and connector 54 is connected to a standby telecommunications switching module. Signals transmitted by the active telecommunications switching module traverse cable 56, junction 60 and are output via common cable 62. Signals received from a remote endpoint traverse common cable 62 and are distributed to both the active and standby switching modules via cables 56 and 58, respectively. If the active-switching module fails, the standby switching module begins operating in the active mode and transmits data to the remote endpoint via cable 58 and common cable 62.

Conventional Y-cable-based communications systems offer some level of redundancy to compensate for local equipment failures. FIG. 1B illustrates a conventional Y-cable-based communications system 100. Y-cable-based communications system 100 includes an active transceiver module 102, a standby transceiver module 104, a remote endpoint 106, such as a receiver, and a Y cable 50. Active transceiver module 102 and standby transceiver module 104 communicate with the remote endpoint 106 via Y cable 50. Here, it should be noted that active transceiver module 102 and standby transceiver module 104 include receiving capabilities (as discussed further below) and remote endpoint 106 will typically include transmitting capabilities.

As described above, Y cable 50 includes an active-side cable 56, a standby-side cable 58, a junction 60 and a common cable 62. Junction 60 connects common cable 62 to both active-side cable 56 and standby-side cable 58. As shown in FIG. 1, Y cable 50 is typically bidirectional to accommodate bidirectional communications, which would be the case when transceivers are employed as discussed above. Junction 60 may be a hard-wired connection, a splitter, a coupler, or the like, and can include isolation to isolate each of the cables from each other while allowing signal propagation.

During normal operation, a transmitter in active transceiver module 102 transmits signals via active-side cable 56 and standby transceiver module 104 does not transmit signals over standby-side cable 58. When, however, an active transceiver module 102 failure is detected, some mechanism is employed to stop transmissions from active transceiver module 102 and begin transmissions from standby transceiver module 104.

FIG. 2 illustrates a Y cable-based signal transmitter arrangement 200 including conventional active-side monitoring capabilities. FIG. 2 shows an active-side 202 and standby-side 204 that include active transceiver module 102 and standby transceiver module 104, respectively. Active transceiver module 102 includes a transmitter 206, a receiver 208, a monitoring/processing/control block 210 and a monitor 212. Standby transceiver module 104 includes a monitor 213, a transmitter 214, a receiver 216 and a monitoring/processing/control block 218. Y cable 50 is also shown and includes a transmit interface comprising active-side transmit line 220, standby-side transmit line 222 and common cable transmit line 224. Y cable 50 also includes a receive interface comprising active-side receive line 226, standby-side receive line 228 and common cable receive line 230. The term “line” as used herein denotes one or more conductors, optical fibers, or waveguides. Junction 60 provides continuity for signal propagation within the transmit interface and separately within the receive interface, as shown. As can be appreciated from FIG. 2, active-side transmit line 220 and receive line 226 are part of active-side cable 56, and standby-side transmit line 222 and receive line 228 are part of standby-side cable 58.

Monitors 212 and 213 monitor transmission signals about to be transmitted onto the Y cable by active-side and standby-side transmitters 206 and 214, respectively, via lines 232 and 233 and junctions 234 and 235. The signals are monitored prior to line drivers 236 and 238, which drive the transmission signals onto the Y cable under the control of respective monitoring/processing/control blocks 210 and 218. That is, monitors 212 and 213 do not monitor transmissions at the Y cable, since monitoring point junctions 234 and 235 are isolated from the Y cable by drivers 236 and 238, respectively. Accordingly, standby-side monitor 213 does not monitor transmissions on the Y cable from active-side transmitter 206.

In operation, active transceiver module 102 operates to transmit and receive signals via transmitter 206 and receiver 208, respectively. Monitoring/processing/control block 210 processes signals for transmission and forwards them to transmitter 206 and also processes signals received by receiver 208. Monitoring/processing/control block 210 also monitors receiver 208 for receiver failure and active-side monitor 212 for alarms concerning a loss of transmission by transmitter 206. Should either of these events occur on the active side 202 (and not on standby side 204) monitoring/processing/control block 210 stops transmissions from transmitter 206 and sends an instruction to monitoring/processing/control block 218 in standby-side transmitter module 104 to enabled transmitter 214 to begin transmitting in place of transmitter 206.

Some of the signals received at receiver 208 and/or receiver 216 provide an indication regarding whether or not the remote endpoint correctly received the transmission from either of transmitter 206 or transmitter 214. For example, negative acknowledgment signals or commands indicating that the signal was incorrectly received at the remote endpoint may be received and processed by either or both of receiver 208 and receiver 216 in conjunction with monitoring/processing/control block 210 and processing/control block 218, respectively. Signals such as these indicating an incorrect receipt of transmissions at the remote endpoint will be referred to herein as a transmit failure indication. One example of the transmit failure indication is a remote failure indication (RFI) that is sent by remote endpoints in a telecommunications switching system. RFIs from remote endpoints have conventionally been used to alert a transmitter as to whether a transmission should be repeated due to incorrect receipt, or no receipt of the signal. Failure indications, however, have not been used in determining whether a standby transmitter should be activated in a Y-cable-based transmitter system. The reason is because failure indications are received by both active and standby receivers 208 and 216 and conventional wisdom is that identical failure conditions therefore result on both active and standby sides 202 and 204 that would either cancel out each other or cause repeated switching back and forth between active and standby transmitters. In addition, transmissions by the active-side and standby-side transmitters are conventionally monitored at the transmitters before the line drivers, and not at the Y cable, as discussed above. Such monitoring has limited use in determining whether a standby transmitter should be activated in a Y-cable-based transmitter system.

A need therefore exists for using transmit failure indications either alone or in conjunction with the monitoring of active and/or standby sides of the Y cable in determining whether a standby transmitter should be activated in a Y-cable-based transmitter system.

### SUMMARY

In one aspect of the subject matter disclosed herein, a method is disclosed for providing redundancy protection in a Y-cable-based signal transmitter arrangement having at least one first transmitter operating in an active mode and a second transmitter operating in a standby mode, wherein operating in the active mode includes transmitting data to a remote endpoint via a Y cable and a transmit interface. The method includes monitoring data transmitted by the first transmitter to the remote endpoint for a loss of signal condition and monitoring, via a receive interface connected to the Y cable, communications from the remote endpoint for a transmit failure indication. A determination is made as to whether to switch the second transmitter to the active mode based on a combination of the loss of signal condition and the transmit failure indication.

In another aspect of the subject matter disclosed herein, a method is disclosed for providing redundancy protection in a Y-cable-based signal transmitter arrangement having at least one first transmitter operating in an active mode and a second transmitter operating in a standby mode, wherein operating in the active mode includes transmitting data to a remote endpoint via a Y cable and a transmit interface. The method includes monitoring, via a receive interface connected to a Y cable, communications from the remote endpoint for a first transmit failure indication. In response to detecting the first transmit failure indication, the second transmitter is switched to an active mode, communications from the remote endpoint are monitored for a second transmit failure indication, and a cause of the first transmit failure indication is determined based on whether the second transmit failure indication is detected.

In another aspect of the subject matter disclosed herein, a system is disclosed for providing redundancy protection in a Y-cable-based signal transmitter arrangement having at least one first transmitter operating in an active mode and a second transmitter operating in a standby mode, wherein operating in the active mode includes transmitting data to a remote endpoint via a Y cable and a transmit interface. The system includes at least one monitor for monitoring data transmitted by the first transmitter to the remote endpoint for a loss of signal condition and at least one receiver for monitoring communications from the remote endpoint for a transmit failure indication via a receive interface and the Y cable. The system also includes a protection controller for receiving and processing information from the at least one receiver and at least one monitor and for determining whether to switch the second transmitter to an active mode based on a combination of the loss of signal condition and the transmit failure indication.

In another aspect of the subject matter disclosed herein, a system is disclosed for providing redundancy protection in a Y-cable-based signal transmitter arrangement having at least one first transmitter operating in an active mode and a second transmitter operating in a standby mode, wherein operating in the active mode includes transmitting data to a remote endpoint via a Y cable and a transmit interface. The system includes at least one receiver for monitoring, via a receive interface and a Y cable, communications from the remote endpoint for a first transmit failure indication and a protection controller for, in response to detecting the first transmit failure indication, switching the second transmitter to the active mode, monitoring communications from the remote endpoint for a second transmit failure indication, and determining a cause of the first transmit failure indication based on whether the second transmit failure indication is detected.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1A is a schematic diagram illustrating an example of a conventional Y cable;

FIG. 1B is a block diagram illustrating a conventional Y-cable-based transmission system;

FIG. 2 is a block diagram illustrating a conventional Y-cable-based signal transmitter arrangement;

FIG. 3 is a block diagram illustrating a system for providing redundancy protection in a Y-cable-based signal transmitter arrangement according to an aspect of the subject matter disclosed herein;

FIG. 4 is a block diagram illustrating a system for providing redundancy protection in a Y-cable-based signal transmitter arrangement according to another aspect of the subject matter disclosed herein;

FIG. 5A is a block diagram illustrating one implementation of protection controller according to another aspect of the subject matter disclosed herein;

FIG. 5B is a block diagram illustrating another implementation of protection controller according to another aspect of the subject matter disclosed herein;

FIG. 6 is a flow chart illustrating a method for providing redundancy protection in a Y-cable-based signal transmitter arrangement according to an aspect of the subject matter disclosed herein;

FIG. 7 is a flow chart illustrating a method for providing redundancy protection in a Y-cable-based signal transmitter arrangement according to another aspect of the subject matter disclosed herein;

FIG. 8 is a block diagram illustrating a system for providing redundancy protection in a Y-cable-based signal transmitter arrangement according to yet another aspect of the subject matter disclosed herein;

FIG. 9 is a flow chart illustrating a method for providing redundancy protection in a Y-cable-based signal transmitter arrangement according to yet another aspect of the subject matter disclosed herein; and

FIG. 10 is a block diagram illustrating a system for providing redundancy protection in a Y-cable-based signal transmitter arrangement according to yet another aspect of the subject matter disclosed herein.

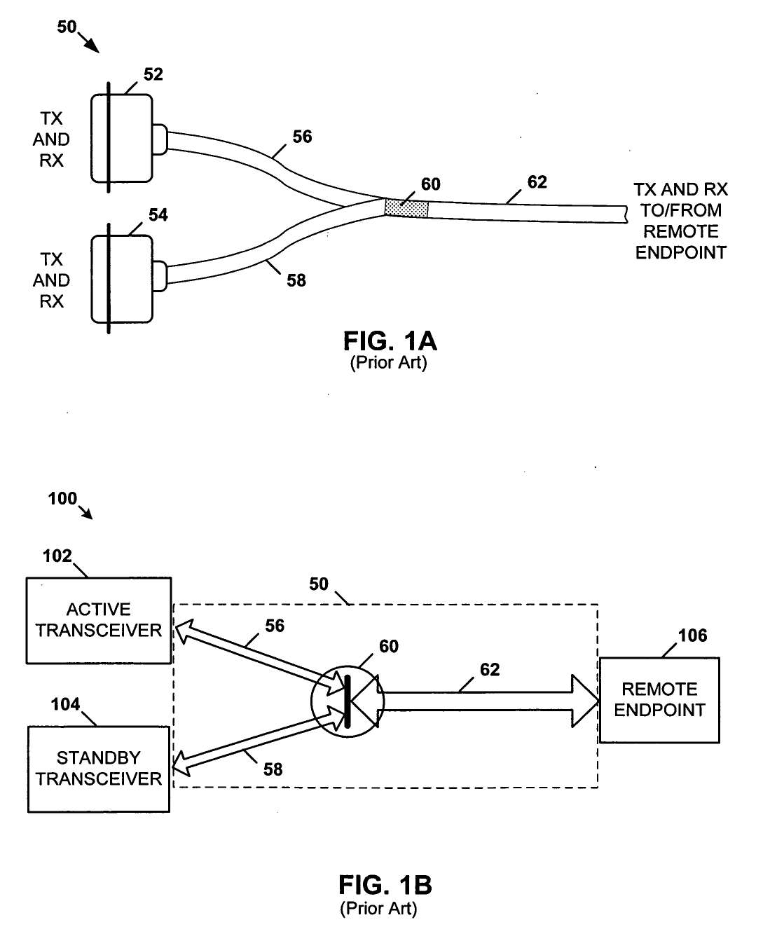

### DETAILED DESCRIPTION OF THE INVENTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Thus, the invention can be embodied in many different forms, and all such forms are contemplated to be within the scope of what is claimed. Any such form of embodiment can be referred to herein as “logic configured to” perform a described action, or alternatively as “logic that” performs a described action.

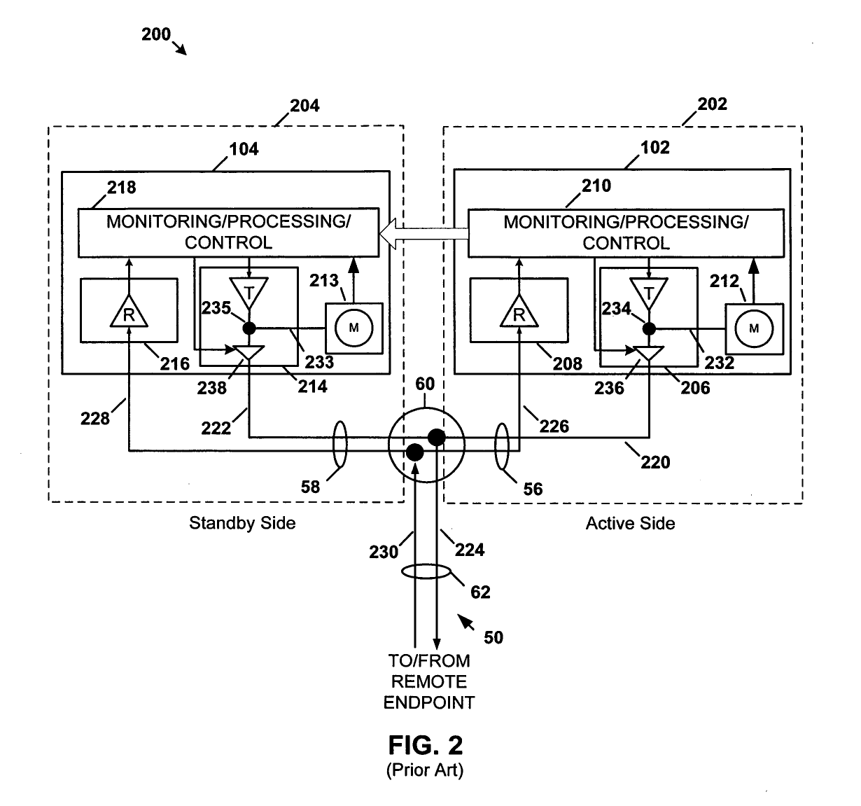

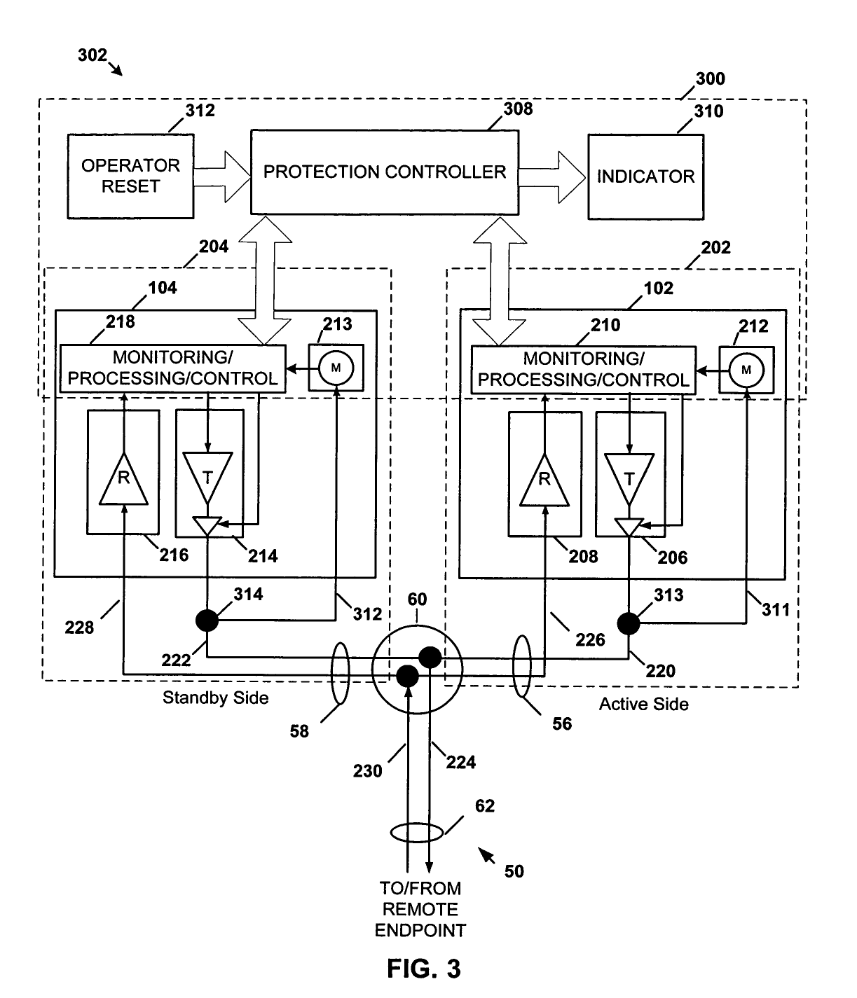

FIG. 3 illustrates a system 300 for providing redundancy protection in a Y-cable-based signal transmitter arrangement 302 according to an aspect of the subject matter disclosed herein. As shown in FIG. 3, a redundancy protection system 300 includes standby-side monitor 213, standby-side monitoring/processing/control block 218, active-side monitor 212, and active-side monitoring/processing/control block 210. Also included in redundancy protection system 300 are a protection controller 308, an indicator 310, and an operator reset 312. Active-side monitor 212 monitors transmissions from the currently active transmitter (206 or 214) at an active-side transmit interface line 220 via line 232 and junction 234. Standby-side monitor 213 monitors transmissions from the currently active transmitter (206 or 214) at a standby-side transmit interface line 222 via line 312 and junction 314. Active-side monitor 212 and standby-side monitor 213 may alternatively be combined into a single monitor that performs the functions of both monitors. Note here that the monitoring is done at the active-side and standby-side transmit interface lines 220 and 222, instead of at the transmitter and before the line driver as in conventional Y-cable-based systems. The remaining components in Y-cable-based signal transmitter arrangement 302 are similar to those described above in connection with FIG. 2.

In operation, active-side monitor 212 and standby-side monitor 213 monitor transmissions from whichever transmitter is currently in the active-mode, which would initially be active-side transmitter 206. When a loss of signal condition is detected, active-side monitor 212 and/or standby-side monitor 213 send an “alarm” signal to monitoring/processing/control block 210 and/or monitoring/processing/control block 218, respectively. Similarly, when a transmit failure indication is received from the remote endpoint at receiver 208 and/or receiver 216, the transmit failure indication is processed by monitoring/processing/control block 210 and/or monitoring/processing/control block 218, respectively. It should be noted here that the signals transmitted and received can be electrical signals traveling via electrical conductors, optical signals traveling via optical fibers, microwave signals traveling via microwave waveguides, or any combination thereof. Also, as described above, the term “transmit failure indication” as used herein denotes a signal or message indicating or tending to indicate that a prior transmission was not received correctly by a remote endpoint. The exact makeup of the transmit failure indication will vary according to the transmission medium used and the particular protocol used, and will not be discussed in detail here. One of ordinary skill in this art, however, will appreciate that many signal transmission protocols include acknowledgment type messages that are returned in response to transmissions and that tend to indicate whether or not a transmission was received correctly by a remote endpoint. These messages are read and information therein is used by protection controller 308.

Loss of signal and transmit failure indication information is gathered by protection controller 308 and analyzed to determine whether to perform a switchover. That is, in one implementation, protection controller 308 determines whether or not to perform a switchover based on a combination of three inputs, one from each of active-side monitor 212 and standby-side monitor 213, and a transmit failure indication from the remote endpoint. The term switchover is used herein to denote disabling the active-side transmitter 206 from transmitting via the Y cable and enabling the standby-side transmitter 214 to begin transmitting via the Y cable. During a switchover, standby-side transmitter 214 is transitioned from a standby mode in which it does not transmit to the remote endpoint via the Y cable to an active mode in which it does transmit to the remote endpoint via the Y cable, and the opposite case is true for transmitter 206.

Since there are three inputs, each having two possible states, there are 2³=8 possible combinations. One of the combinations correspond to no alarms from either of active-side monitor 212 and standby-side monitor 213 and no transmit failure indication from the remote endpoint, which corresponds to normal operation and need not be discussed further here since no protection-related actions are needed. The remaining seven combinations, along with the corresponding conclusions and actions, are shown in Table 1 below and numbered as scenarios 1.1 to 1.6. Note that scenario 1.1 includes two possible combinations of inputs that results in the same conclusion and action.

TABLE 1
Failure Conditions and Proposed Actions

| Condition | | | | | |
|---|---|---|---|---|---|
| | | | Transmit Failure | | |
| | Active-side | Standby- | Indication from | | |
| # | Monitor | Side Monitor | Remote Endpoint | Conclusion | Action |
| 1.1 | Alarm | Alarm | Yes or No | active transmitter failed | Switchover |
| 1.2 | Normal | Normal | Yes | common cable failed | None |
| 1.3 | Alarm | Normal | Yes | active transmitter failed and | Switchover |
| | | | | standby-side monitor failed | |
| 1.4 | Alarm | Normal | No | active-side monitor failed | Switchover |
| 1.5 | Normal | Alarm | No | standby-side monitor and/or | Standby-side unusable - |
| | | | | standby-side cable failed | prevent switchovers |
| 1.6 | Normal | Alarm | Yes | active transmitter failed and | Switchover |
| | | | | active-side monitor failed, | |
| | | | | or the active-side cable failed | |

As can be appreciated from Table 1, there are three possible actions for each combination of inputs. The three possible actions are switchover, no switchover, and preventing switchovers. In addition, there are several conclusions that can be reached by protection controller 308 and indicated to an operator through indicator 310. Indicator 310 can be one or more status lamps or can be a display supported by a computing system. Indicator 310 can be located locally or can be remotely located and can communicate with protection controller either directly or through a network (not shown), such as a local area network, wide area network, the Internet, or any combination of these. The various scenarios 1.1 to 1.6 of Table 1 are discussed further below.

When a switchover is performed, a switchover flag is set by protection controller 308. The switchover flag is used to inform an operator that a switchover has taken place in an attempt to resolve a detected problem and to prevent excessive switchovers in cases when the switchover does not resolve the problem. Once the switchover flag is set, no further switchovers can take place for the same condition until an operator manually clears the flag. The switchover flag may be, for example, a register or other memory device accessible to protection controller 308 and either internal or external to protection controller 308. When an operator resets the switchover flag, operator reset 312 sends an indication to protection controller 308. For example, operator reset 312 may be a local momentary switch or a command received through a network from a remotely located operator's console.

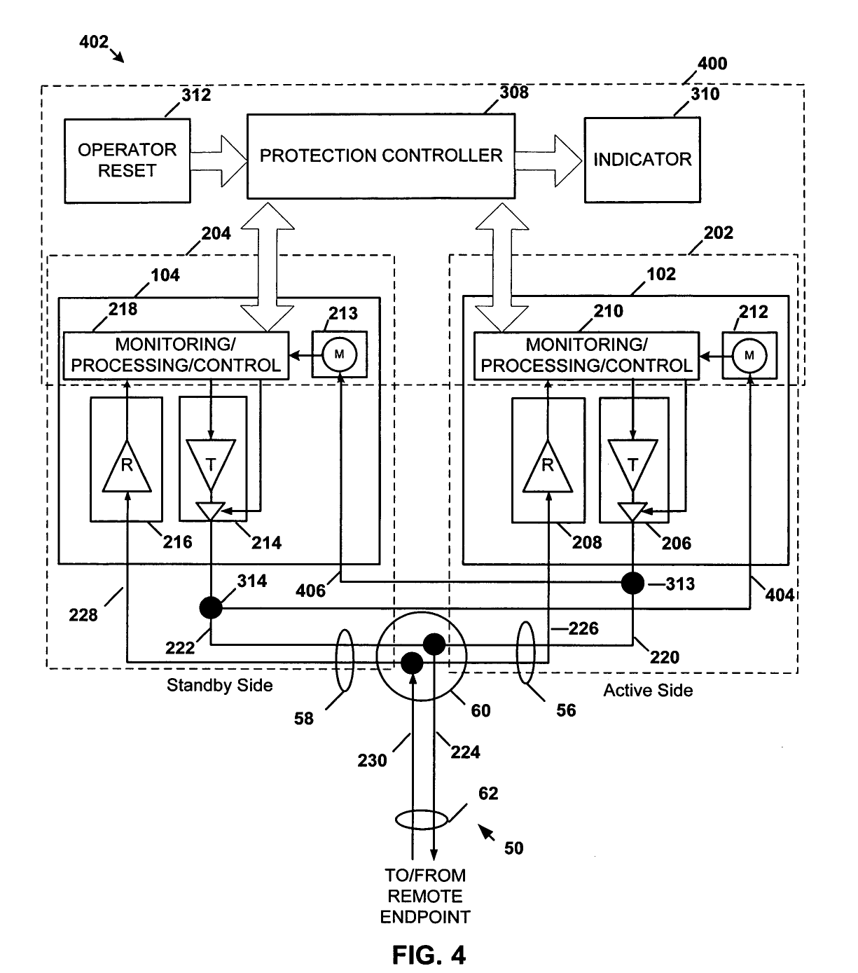

FIG. 4 illustrates an alternate system 400 for providing redundancy protection in a Y-cable-based signal transmitter arrangement 402 according to another aspect of the subject matter disclosed herein. As shown in FIG. 4, once again, redundancy protection system 400 includes standby-side monitor 213, standby-side monitoring/processing/control block 218, active-side monitor 212, active-side monitoring/processing/control block 210, protection controller 308, an indicator 310, and operator reset 312. In this embodiment, however, active-side monitor 212 is connected to a standby-side transmit interface line 222 via line 404 and junction 314. Likewise, standby-side monitor 213 is connected to an active-side transmit interface line 220 via line 406 and junction 234. Accordingly, this arrangement is referred to herein as the cross-over arrangement. The remaining components in Y-cable-based signal transmitter arrangement 402 are similar to those described above in connection with FIG. 2.

Functionally, the connection shown in FIG. 4 may be similar to those illustrated in FIG. 3 in that monitors 212 and 213 each monitor the output of the transmitter currently functioning in the active mode. In FIG. 3, however, the connection between the monitors and the transmitters on the opposite sides may be made via junction 60 in Y cable 50. In the cross-over arrangement shown in FIG. 4, the connection between the monitors and the transmitters on the opposite sides may be made via wires that are separate from Y cable 50, as indicated by reference numerals 404 and 406.

Returning to FIG. 4, in operation, active-side monitor 212 and standby-side monitor 213 initially monitor transmissions from active-side transmitter 206. If a transmit failure is detected and a switchover occurs, both monitors will monitor transmissions from standby-side transmitter 214 (which is now functioning in the active-mode). Because each transmitter is connected via an additional line (404 or 406) to a monitor associated with the other side, which may be a different telecommunications switching card, the arrangement illustrated in FIG. 4 provides increased redundancy over the arrangement illustrated in FIG. 3.

Table 2 below shows the various combinations of inputs, along with the corresponding conclusions and actions, of the cross-over arrangement, which are numbered as scenarios 2.1 to 2.6. The actions and conclusions reached are different than those in Table 1, as can be appreciated from a comparison of Tables 1 and 2.

TABLE 2
Failure Conditions and Proposed Actions for Cross-over Arrangement

| Condition | | | | | |
|---|---|---|---|---|---|
| | | | Transmit Failure | | |
| | Active-Side | Standby- | Indication from | | |
| # | Monitor | Side Monitor | Remote Endpoint | Conclusion | Action |
| 2.1 | Alarm | Alarm | Yes or No | active transmitter failed | Switchover |
| 2.2 | Normal | Normal | Yes | common cable failed | None |
| 2.3 | Alarm | Normal | Yes | active transmitter failed and | Switchover |
| | | | | standby-side monitor failed, | |
| | | | | or active-side cable failed | |
| 2.4 | Alarm | Normal | No | active-side monitor failed and/or | Standby-side unusable - |
| | | | | standby-side cable failed | prevent switchovers |
| 2.5 | Normal | Alarm | No | standby-side monitor failed | None |
| 2.6 | Normal | Alarm | Yes | active transmitter failed and | Switchover |
| | | | | active-side monitor failed | |

As discussed above, protection controller 308 includes logic configured to analyze information obtained via monitoring/processing/control blocks 210 and 218 from each of active-side monitor 212, standby-side monitor 213 and transmit failure indications received via either or both of receivers 208 and 216. Protection controller 308 can take on many forms and can be separate from transmitter modules 102 and 104 or can be a part of either transmitter module 102 or 104 or both. Moreover, it will be recognized that protection controller 308 can take on any form, e.g., a system, apparatus, or device, such as a computer-based system or processor containing system, so long as the various actions described herein can be performed. For example, protection controller 308 can be implemented using specialized circuits or circuitry (e.g., discrete logic gates interconnected to perform a specialized function) or can be implemented via program instructions being executed by one or more processors, or by a combination of both. In addition, the sequences of actions described herein can be embodied in a computer-readable medium for use by or in connection with protection controller 308 to fetch the instructions from the computer-readable medium and execute the instructions.

In any event, protection controller 308 receives monitor alarm and transmit failure indication information collected at monitoring/processing/control blocks 210 and 218, analyzes the information and performs an action based on the information according to Table 1 for the standard arrangement shown in FIG. 3, or according to Table 2 for the cross-over arrangement shown in FIG. 4. In one embodiment, Tables 1 and/or 2 can be implemented as lookup tables stored in a memory (not shown) associated with protection controller 308. When a set of input conditions is forwarded to and analyzed by protection controller 308, protection controller 308 performs a lookup operation in a lookup table and fetches a corresponding action and conclusion. For example, assuming the standard arrangement of FIG. 3 and a set of input conditions according to scenario 1.3 of Table 1, protection controller 308 would fetch the corresponding action from a lookup table corresponding to Table 1 and would initiate a switchover accordingly. In addition, protection controller 308 may also fetch the corresponding conclusion and indicate it to an operator, either locally or remotely, via indicator 310.

Further analysis of Table 1 yields the following observations regarding when a switchover is to occur. Switchovers occur for scenarios 1.1, 1.3, 1.4 and 1.6. In each of scenarios 1.1, 1.3 and 1.4, the active-side monitor 212 provides an alarm signal as input. This is not the case for non-switchover scenarios 1.2 and 1.5. In the only other switchover scenario, scenario 1.6, active-side monitor 212 is not in alarm, but standby-side monitor 213 is in alarm and a transmit failure indication is received. Once again, this is not the case for non-switchover scenarios 1.2 and 1.5. Accordingly, an exemplary implementation of protection controller 308 can be to initiate a switchover when either of these two conditions is detected. That is, a switchover is initiated when either (or both):

1. active-side monitor 212 is in alarm; or

2. standby-side monitor 213 is in alarm and a transmit failure indication is received.

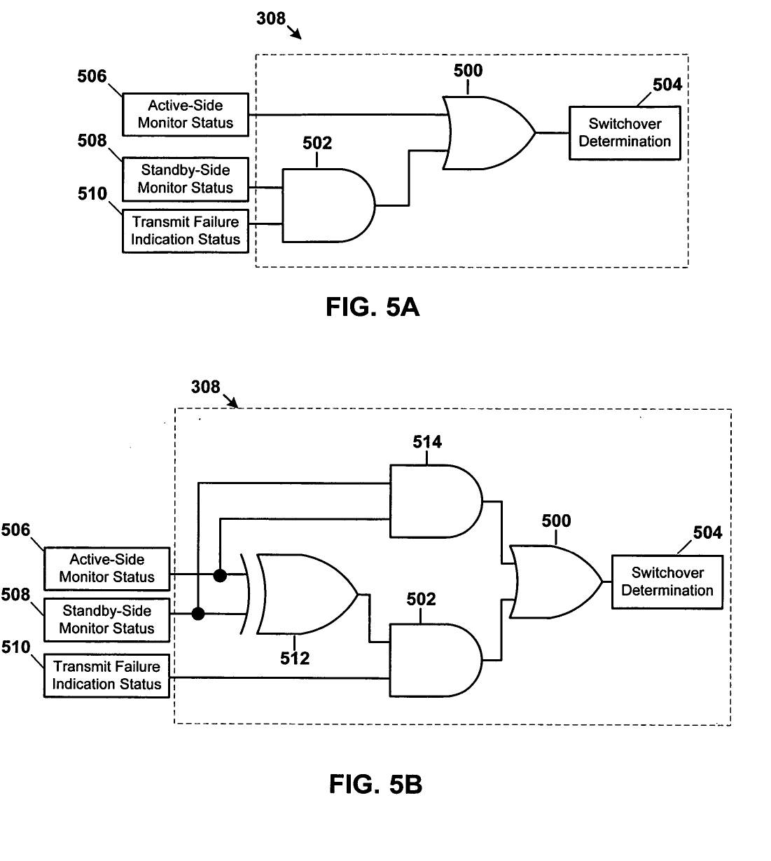

FIG. 5A illustrates one implementation of protection controller 308 according to another aspect of the subject matter disclosed herein. FIG. 5A includes OR gate 500, AND gate 502, switchover determination 504, active-side monitor status 506, standby-side monitor status 508 and transmit failure indication status 510. As can be appreciated by one of ordinary skill in this art, when active-side monitor status 506 is in alarm, i.e., is a logic ‘high’, switchover determination 504 will change accordingly, thus initiating a switchover. In addition, when both standby-side monitor status 508 is in alarm, i.e., is a logic ‘high’, and a transmit failure indication is received, switchover determination 504 will also change accordingly, thus initiating a switchover. Accordingly, protection controller 308 can be implemented as shown in FIG. 5A for determining when a switchover should take place.

FIG. 5B illustrates another implementation of protection controller 308 according to another aspect of the subject matter disclosed herein. FIG. 5B includes the same components as FIG. 5A and the addition of an XOR gate 512 and a second AND gate 514. FIG. 5B corresponds to a simplification of Table 2 for the cross-over arrangement. In this case, a switchover is initiated for scenarios 2.1, 2.3, or 2.6. A switchover is therefore initiated when either (or both):

1. both active side monitor 212 and standby-side monitor 213 is in alarm; or

2. only one of active-side monitor 212 and standby-side monitor 213 is in alarm and a transmit failure indication is received. Such is the case in scenarios 2.1, 2.3, and 2.6, but not in non-switchover scenarios 2.2, 2.4, and 2.5.

In addition to determining when to switchover, protection controller 308 may also determine when to prevent future switchovers from taking place until the cause of the current failure issue has been addressed. For example, scenario 1.5 of Table 1 and scenario 2.4 of Table 2 each determine that either the standby-side cable or the monitor currently monitoring the standby-side transmitter has failed and thus the standby-side transmitter should not be employed via a switchover.

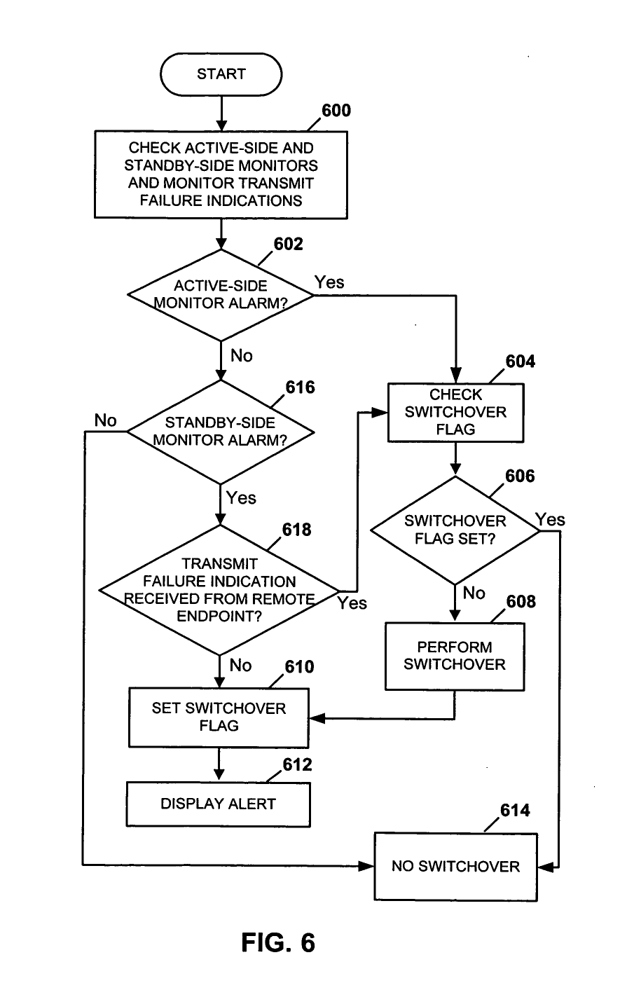

FIG. 6 is a flow chart illustrating a method for providing redundancy protection in a Y-cable-based signal transmitter arrangement according to an aspect of the subject matter disclosed herein. In step 600, protection controller 308 determines the status of active-side monitor 212 and standby-side monitor 213, and whether a transmit failure indication has been received. If protection controller 308 determines there is an active-side monitor alarm in step 602, the switchover flag is checked in step 604 and protection controller 308 determines in step 606 whether the switchover flag is set. If the switchover flag is not set, a switchover is performed in step 608, the switchover flag is set in step 610 and an alert corresponding to the conclusion is displayed via indicator 310 in step 612. Returning to step 606, if protection controller 308 determines the switchover flag is set, no switchover is performed (step 614). This is to prevent excessive switchovers, as described above.

Returning to step 602, if protection controller 308 determines there is no active-side monitor alarm, protection controller 308 determines whether there is a standby-side monitor alarm in step 616. If protection controller 308 determines that there is no standby-side monitor alarm in step 616, no switchover is performed (step 614). If, however, protection controller 308 determines that there is a standby-side monitor alarm in step 616, then protection controller 308 determines whether a transmit failure indication has been received in step 618. If a transmit failure indication has been received, control transfers to step 604 where the switchover flag is checked and to step 606 where protection controller 308 determines whether the switchover flag is set. Once again, if the switchover flag is not set, a switchover is performed in step 608, the switchover flag is set in step 610, and an alert corresponding to the conclusion is displayed via indicator 310 in step 612.

Returning to step 618, if protection controller 308 determines that no transmit failure indication has been received, this corresponds to scenario 1.5 of Table 1. Accordingly, future switchovers are prevented by setting the switchover flag in step 610 (even though no switchover has occurred) and the corresponding alert is displayed (step 612).

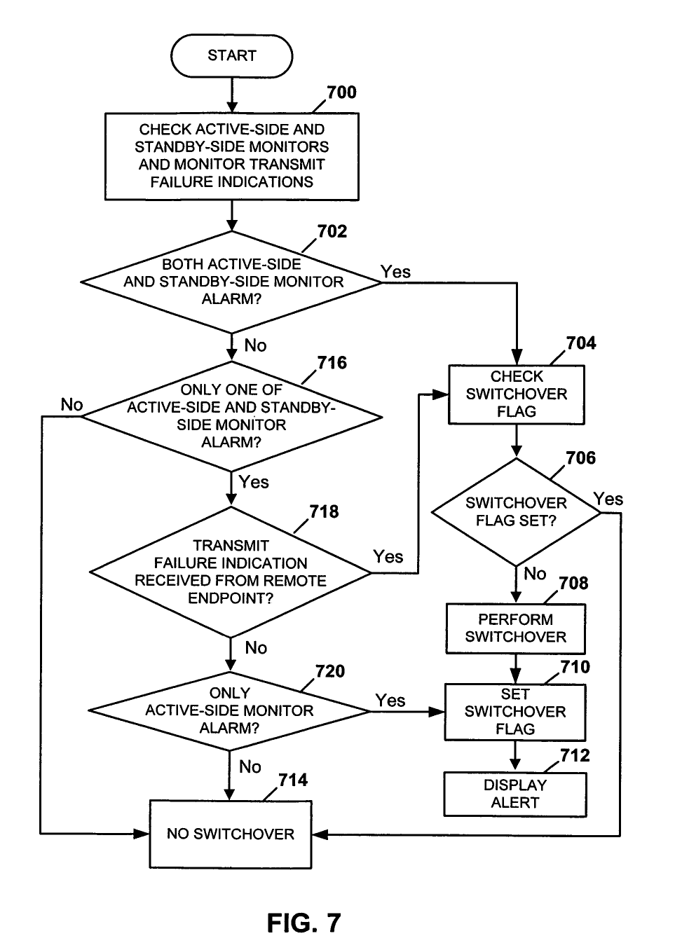

FIG. 7 is a flow chart illustrating a method for providing redundancy protection in a Y-cable-based signal transmitter arrangement according to another aspect of the subject matter disclosed herein. The method illustrated by FIG. 7 corresponds to the cross-over arrangement of FIG. 4. In step 700, protection controller 308 determines the status of active-side monitor 212 and standby-side monitor 213, and whether a transmit failure indication has been received. If protection controller 308 determines there is both an active-side monitor alarm and standby-side monitor alarm in step 702, the switchover flag is checked in step 704 and protection controller 308 determines in step 706 whether the switchover flag is set. If the switchover flag is not set, a switchover is performed in step 708, the switchover flag is set in step 710 and an alert corresponding to the conclusion is displayed via indicator 310 in step 712. Returning to step 706, if protection controller 308 determines the switchover flag is set, no switchover is performed (step 714). This is to prevent excessive switchovers, as described above.

Returning to step 702, if protection controller 308 determines there is not both an active-side monitor alarm and standby-side monitor alarm, protection controller 308 determines whether there is only one of an active-side monitor alarm and a standby-side monitor alarm in step 716. If protection controller 308 determines that there is neither an active-side monitor alarm nor a standby-side monitor alarm in step 716, no switchover is performed (step 714). If, however, protection controller 308 determines that there is one of an active-side monitor alarm and a standby-side monitor alarm in step 716, then protection controller 308 determines whether a transmit failure indication has been received in step 718. If a transmit failure indication has been received, control transfers to step 704 where the switchover flag is checked and to step 706 where protection controller 308 determines whether the switchover flag is set. Once again, if the switchover flag is not set, a switchover is performed in step 708, the switchover flag is set in step 710, and an alert corresponding to the conclusion is displayed via indicator 310 in step 712.

Returning to step 718, if protection controller 308 determines that no transmit failure indication has been received, protection controller 308 determines in step 720 if the one monitor alarm (from step 716) is an active-side monitor alarm, which, if true, corresponds to scenario 2.4 of Table 1. Accordingly, future switchovers are prevented by setting the switchover flag in step 710 (even though no switchover has occurred) and the corresponding alert is displayed (step 712). If, however, protection controller 308 determines that the one monitor alarm (from step 716) is a standby-side monitor alarm in step 720, no switchover is performed (step 714).

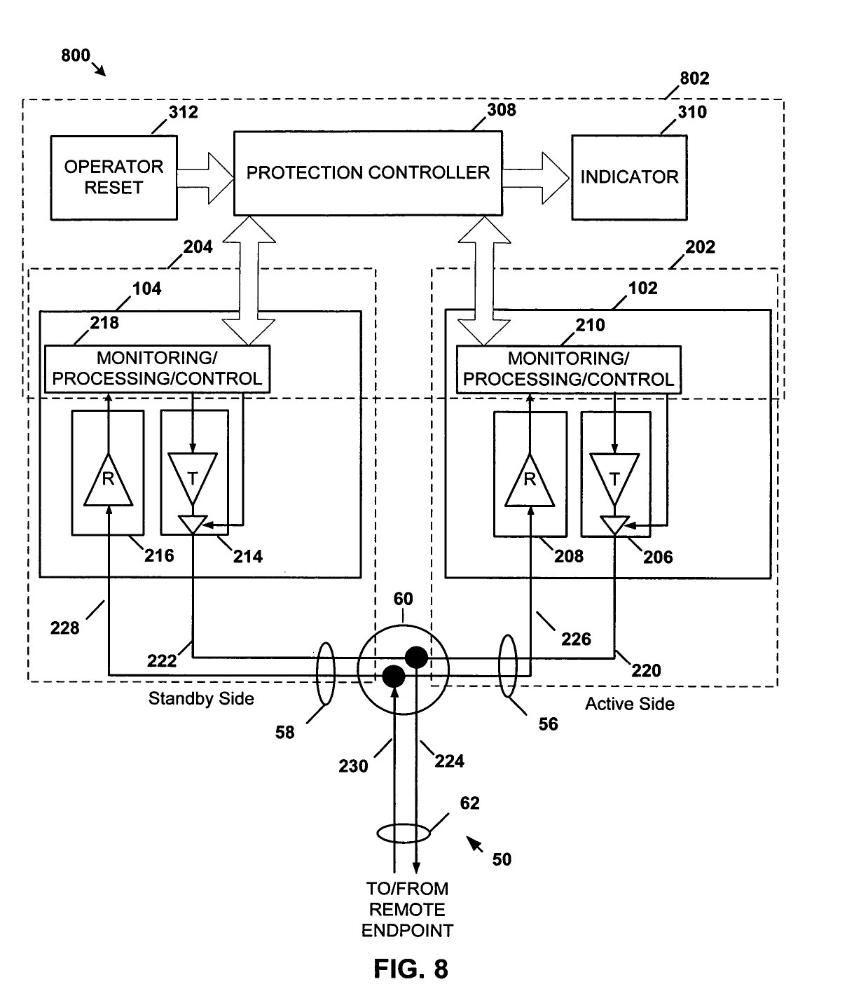

FIG. 8 illustrates a system for providing redundancy protection in a Y-cable-based signal transmitter arrangement 800 according to yet another aspect of the subject matter disclosed herein. As shown in FIG. 8, redundancy protection system 802 includes standby-side monitoring/processing/control block 218, active-side monitoring/processing/control block 210, protection controller 308 and an indicator 310. In this embodiment, however, active-side monitor 212 and standby-side monitor 213 are not required. The absence of a requirement to monitor outgoing transmissions makes this arrangement more attractive for implementation in current Y-cable-based systems that lack monitors. The remaining components in Y-cable-based signal transmitter arrangement 800 are substantially described above in connection with FIG. 3.

In operation, when a transmit failure indication is received from the remote endpoint at receiver 208 and/or receiver 216, the transmit failure indication is processed by monitoring/processing/control block 210 and/or monitoring/processing/control block 218, respectively. Based on the receipt of a transmit failure indication, protection controller 308 automatically performs a switchover and then monitors for a second transmit failure indication. Based on the presence or absence of the second transmit failure indication, an alert is displayed via indicator 310.

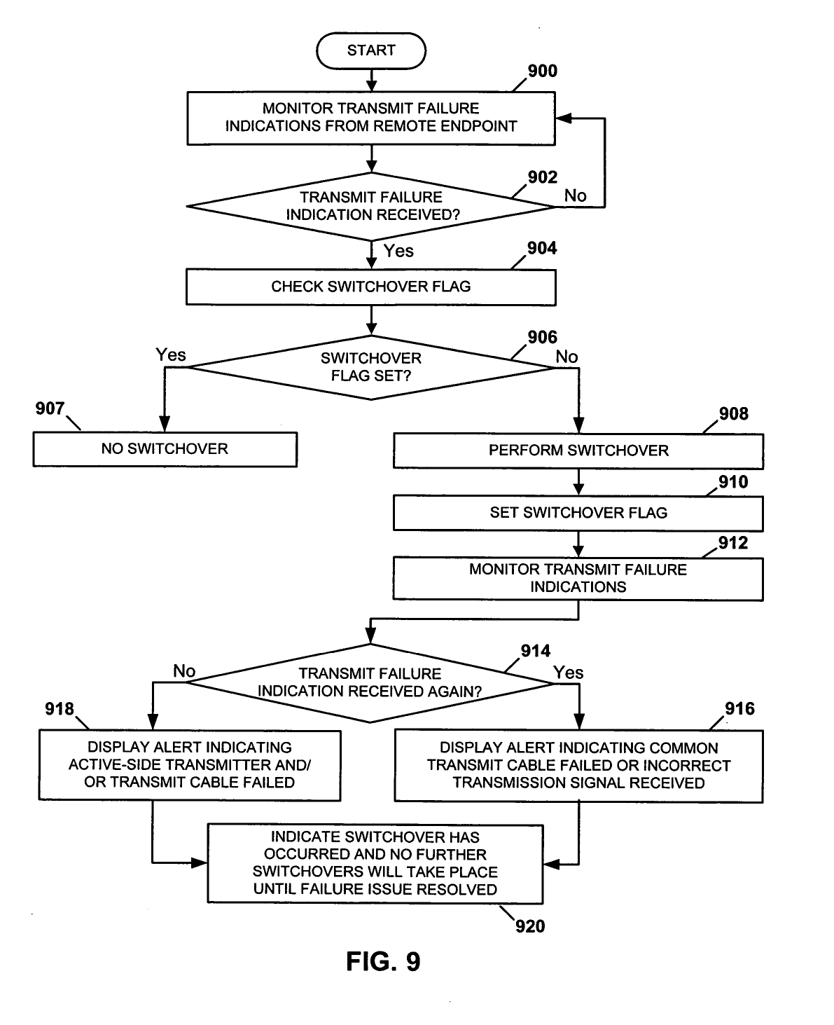

FIG. 9 is a flow chart illustrating a method for providing redundancy protection in the Y-cable-based signal transmitter arrangement of FIG. 8 according to yet another aspect of the subject matter disclosed. In steps 900 and 902, protection controller 308 monitors for the receipt of a transmit failure indication. If protection controller 308 determines that a transmit failure indication has been received in step 902, the switchover flag is checked in step 904, and protection controller 308 determines whether the switchover flag is set in step 906. If the switchover flag is not set, a switchover is performed in step 908 and the switchover flag is set in step 910. If, however, the switchover flag is set, no switchover is performed in step 907.

In steps 912 and 914, protection controller 308 monitors for the receipt of a second transmit failure indication. Here, for example, protection controller 308 monitors received messages for a predetermined period of time to see if a second transmit failure indication is received. If protection controller 308 determines that a second transmit failure indication has been received in step 914, an alarm is issued via indicator 310 indicating that the common transmit cable failed or an incorrect transmission signal was received in step 916. If, however, protection controller 308 determines that no second transmit failure indication is received, an alarm is issued via indicator 310 indicating that the active-side transmitter and/or transmit cable failed in step 918. In either case, an indication is provided via indicator 310 that a transmit failure indication switchover has occurred and no further switchovers will take place until the failure issue is resolved in step 920.

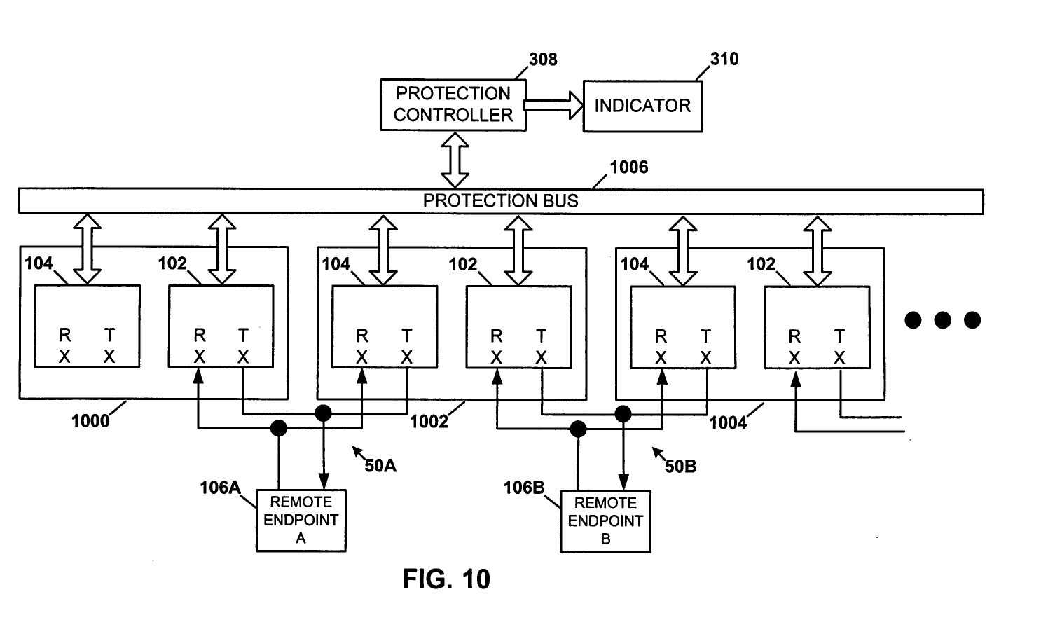

FIG. 10 is a block diagram illustrating a system for providing redundancy protection in a Y-cable-based signal transmitter arrangement according to another aspect of the subject matter disclosed herein. As shown in FIG. 10, three modules 1000, 1002, and 1004, each include active transceiver module 102 and standby transceiver module 104 as sub-modules. Modules 1000, 1002, and 1004 may be, for example, a printed circuit board that has a number of sub-modules. The transceiver sub-modules communicate with protection controller 308 via a protection bus 1006. Alternatively, protection bus 1006 may be omitted and the transceiver modules may each communicate directly with protection controller 308. As shown in FIG. 10, active transceiver sub-module 102 of module 1000 and standby transceiver sub-module 104 of module 1002 connect to the active-side and standby-side of a first Y cable 50A, which is connected to a first remote endpoint 106A. Similarly, active transceiver sub-module 102 of module 1002 and standby transceiver sub-module 104 of module 1004 connect to the active-side and standby-side of a second Y cable 50B, which is connected to a second remote endpoint 106B. Note here that the first and second remote endpoints may be associated with each other or may be the same endpoint. As can be appreciated, the pairs of active and standby transceiver sub-modules 102,104 connected to each Y cable 50A, 50B are associated with different modules 1000, 1002, 1004, thus providing an additional layer of redundancy should one of the modules 1000, 1002, or 1004 fail.

In operation, when protection controller 308 determines that a switchover is needed for remote endpoint 106A, standby transceiver sub-module 104 of module 1002 begins transmitting and active transceiver sub-module 102 of module 1000 stops transmitting. Similarly, when protection controller 308 determines, independently of the switchover determination above, that a switchover is needed for remote endpoint 106B, standby transceiver sub-module 104 of module 1004 begins transmitting and active transceiver sub-module 102 of module 1002 stops transmitting. Using this arrangement, should an entire module 1000, 1002, or 1004 fail, a corresponding standby transceiver sub-module (which is located on a different module) will still be operational to assume transmitting responsibilities after switchover. This cooperative arrangement can be extended to any number of modules beyond the three shown.

It will be understood that various details of the invention may be changed without departing from the scope of the invention. Furthermore, the foregoing description is for the purpose of illustration only, and not for the purpose of limitation, as the invention is defined by the claims as set forth hereinafter.

What is claimed is:

1. A method for providing redundancy protection in a Y-cable-based signal transmitter arrangement having at least one first transmitter operating in an active mode and a second transmitter operating in a standby mode, wherein operating in the active mode includes transmitting data to a remote endpoint via a Y cable and a transmit interface, the method comprising:
(a) monitoring data transmitted by the first transmitter to the remote endpoint for a loss of signal condition;
(b) monitoring, via a receive interface connected to the Y cable, communications from the remote endpoint for a transmit failure indication from the remote endpoint; and
(c) determining whether to switch the second transmitter to the active mode based on a combination of the loss of signal condition and the transmit failure indication from the remote endpoint.

2. The method of claim 1 wherein monitoring data transmitted to a remote endpoint for a loss of signal condition comprises monitoring the data transmitted by the first transmitter using a first monitor and a second monitor.

3. The method of claim 2 wherein the first monitor is associated with the first transmitter and monitors the data transmitted to the remote endpoint at an active side of the transmit interface that connects to the first transmitter.

4. The method of claim 2 wherein the second monitor is associated with the second transmitter and monitors the data transmitted to the remote endpoint at an active side of the transmit interface that connects to the first transmitter.

5. The method of claim 1 wherein the first and second transmitters are associated with first and second transceiver sub-modules, respectively, that are associated with different modules.

6. The method of claim 1 wherein monitoring data transmitted to a remote endpoint for a loss of signal condition comprises monitoring an electrical signal.

7. The method of claim 1 wherein monitoring data transmitted to a remote endpoint for a loss of signal condition comprises monitoring an optical signal.

8. The method of claim 1 wherein monitoring data transmitted to a remote endpoint for a loss of signal condition comprises monitoring a microwave signal.

9. The method of claim 1 wherein monitoring communications from the remote endpoint for a transmit failure indication from the remote endpoint comprises determining from data received from the remote endpoint whether the data transmitted to the remote endpoint was correctly received by the remote endpoint.

10. The method of claim 2 wherein determining whether to switch the second transmitter to the active mode comprises:
(a) determining whether a loss of signal condition is reported by the first monitor; and
(b) in response to determining that the a loss of signal condition is reported by the first monitor, switching the second transmitter to the active mode.

11. The method of claim 10 comprising, in response to determining that a loss of signal condition is not reported by the first monitor:
(a) determining whether a loss of signal condition is reported by the second monitor;
(b) determining whether the transmit failure indication is present; and
(c) in response to determining that the a loss of signal condition is reported by the second monitor and the transmit failure indication is present, switching the second transmitter to the active mode.

12. The method of claim 4 wherein determining whether to switch the second transmitter to the active mode comprises:
(a) determining whether a loss of signal condition is reported by both the first and second monitors; and
(b) in response to determining that the a loss of signal condition is reported by both the first and second monitors, switching the second transmitter to the active mode.

13. The method of claim 4 wherein determining whether to switch the second transmitter to the active mode comprises:
(a) determining whether a loss of signal condition is reported by one of the first and second monitors;
(b) determining whether the transmit failure indication is present; and
(c) in response to determining that the a loss of signal condition is reported by one of the first and second monitors and the transmit failure indication is present, switching the second transmitter to the active mode.

14. The method of claim 1 comprising determining whether to prevent a switching of the second transmitter to the active mode based on a combination of the loss of signal condition and the transmit failure indication.

15. The method of claim 1 comprising, in response to determining to switch the second transmitter to the active mode, displaying an alert indication.

16. The method of claim 15 wherein displaying an alert indication comprises displaying information indicating what initiated the switching of the second transmitter to the active mode.

17. The method of claim 1 wherein determining whether to switch the second transmitter to the active mode is based on whether the second transmitter has previously been switched to active mode, in addition to a combination of the loss of signal condition and the transmit failure indication from the remote endpoint.

18. The method of claim 1 comprising, responsive to determining to switch the second transmitter to the active mode, setting a flag to indicate that the second transmitter has been switched to active mode.

19. A method for providing redundancy protection in a Y-cable-based signal transmitter arrangement having at least one first transmitter operating in an active mode and a second transmitter operating in a standby mode, wherein operating in the active mode includes transmitting data to a remote endpoint via a Y cable and a transmit interface, the method comprising:
(a) monitoring, via a receive interface connected to the Y cable, communications from the remote endpoint for a first transmit failure indication; and
(b) in response to detecting the first transmit failure indication:
(i) switching the second transmitter to an active mode;
(ii) monitoring communications from the remote endpoint for a second transmit failure indication; and
(iii) determining a cause of the first transmit failure indication based on whether the second transmit failure indication is detected.

20. The method of claim 19 wherein monitoring communications from the remote endpoint for a transmit failure indication comprises determining from data received from the remote endpoint whether the data transmitted to the remote endpoint was correctly received by the remote endpoint.

21. The method of claim 19 wherein determining a cause of the first transmit failure indication based on whether the second transmit failure indication is detected comprises determining, in response to not receiving the second transmit failure indication, that the cause is at least one of an active-side transmitter failure and an active-side transmit cable failure.

22. The method of claim 19 wherein determining a cause of the first transmit failure indication based on whether the second transmit failure indication is detected comprises determining, in response to receiving the second transmit failure indication, that the cause is at least one of a common transmit cable failure and an incorrect transmission signal receipt at the remote endpoint.

23. The method of claim 19 comprising, in response to determining a cause of the first transmit failure indication, displaying an alert indication.

24. The method of claim 23 comprising, in response to determining a cause of the first transmit failure indication, displaying an indication of the determined cause.

25. The method of claim 19 wherein switching the second transmitter to the active mode is based on whether the second transmitter has previously been switched to active mode.

26. The method of claim 19 comprising, in response to detecting the first transmit failure indication, setting a flag to indicate that the second transmitter has been switched to active mode.

27. A system for providing redundancy protection in a Y-cable-based signal transmitter arrangement having at least one first transmitter operating in an active mode and a second transmitter operating in a standby mode, wherein operating in the active mode includes transmitting data to a remote endpoint via a Y cable and a transmit interface, the system comprising:
(a) at least one monitor for monitoring data transmitted by the first transmitter to the remote endpoint for a loss of signal condition;
(b) at least one receiver for monitoring communications from the remote endpoint for a transmit failure indication via a receive interface and the Y cable; and
(c) a protection controller for receiving and processing information from the at least one receiver and at least one monitor and for determining whether to switch the second transmitter to an active mode based on a combination of the loss of signal condition and the transmit failure indication.

28. The system of claim 27 wherein the at least one monitor comprises a first monitor and a second monitor.

29. The system of claim 28 wherein the first monitor is associated with the first transmitter and monitors the data transmitted to the remote endpoint at an active side of the transmit interface that connects to the first transmitter.

30. The system of claim 28 wherein the second monitor is associated with the second transmitter and monitors the data transmitted to the remote endpoint at an active side of the transmit interface that connects to the first transmitter.

31. The system of claim 27 wherein the first and second transmitters are associated with first and second transceiver sub-modules, respectively, that are associated with different modules.

32. The system of claim 27 wherein the least one monitor comprises logic configured to monitor an electrical signal.

33. The system of claim 27 wherein the least one monitor comprises logic configured to monitor an optical signal.

34. The system of claim 27 wherein the least one monitor comprises logic configured to monitor a microwave signal.

35. The system of claim 27 wherein the at least one receiver for monitoring communications from the remote endpoint for a transmit failure indication comprises first and second receivers associated with the first and second transmitters, respectively.

36. The system of claim 27 wherein the protection controller comprises logic configured to determine from data received at the least one receiver from the remote endpoint whether the data transmitted to the remote endpoint was correctly received by the remote endpoint.

37. The system of claim 28 wherein the protection controller comprises logic configured to:
(a) determine whether a loss of signal condition is reported by the first monitor; and
(b) in response to determining that a loss of signal condition is reported by the first monitor, switch the second transmitter to the active mode.

38. The system of claim 37 wherein the protection controller comprises logic configured to, in response to determining that a loss of signal condition is not reported by the first monitor:
(a) determine whether a loss of signal condition is reported by the second monitor;
(b) determine whether the transmit failure indication is present; and
(c) in response to determining that a loss of signal condition is reported by the second monitor and the transmit failure indication is present, switch the second transmitter to the active mode.

39. The system of claim 30 wherein the protection controller comprises logic configured to:
(a) determine whether a loss of signal condition is reported by both the first and second monitors; and
(b) in response to determining that a loss of signal condition is reported by both the first and second monitors, switch the second transmitter to the active mode.

40. The system of claim 30 wherein the protection controller comprises logic configured to:
(a) determine whether a loss of signal condition is reported by one of the first and second monitors;
(b) determine whether the transmit failure indication is present; and
(c) in response to determining that a loss of signal condition is reported by one of the first and second monitors and the transmit failure indication is present, switch the second transmitter to the active mode.

41. The system of claim 27 wherein the protection controller comprises logic configured to determine whether to prevent a switching of the second transmitter to the active mode based on a combination of the loss of signal condition and the transmit failure indication.

42. The system of claim 27 comprising logic configured to, in response to determining to switch the second transmitter to the active mode, display an alert indication.

43. The system of claim 42 wherein the logic configured to display an alert indication is configured to display information indicating what initiated the switching of the second transmitter to the active mode.

44. The system of claim 27 wherein the protection controller determines whether to switch the second transmitter to an active mode based on whether the second transmitter has previously been switched to active mode, in addition to a combination of the loss of signal condition and the transmit failure indication.

45. The system of claim 27 wherein the protection controller, in response to determining to switch the second transmitter to an active mode, sets a flag to indicate that the second transmitter has been switched to active mode.

46. A system for providing redundancy protection in a Y-cable-based signal transmitter arrangement having at least one first transmitter operating in an active mode and a second transmitter operating in a standby mode, wherein operating in the active mode includes transmitting data to a remote endpoint via a Y cable and a transmit interface, the system comprising:
(a) at least one receiver for monitoring, via a receive interface and a Y cable, communications from a remote endpoint for a first transmit failure indication; and
(b) a protection controller for, in response to detecting the first transmit failure indication:
(i) switching the second transmitter to the active mode;
(ii) monitoring communications from the remote endpoint for a second transmit failure indication; and
(iii) determining a cause of the first transmit failure indication based on whether the second transmit failure indication is detected.

47. The system of claim 46 wherein the protection controller comprises logic configured to determine from data received at the least one receiver from the remote endpoint whether the data transmitted to the remote endpoint was correctly received by the remote endpoint.

48. The system of claim 46 wherein the protection controller comprises logic configured to determine a cause of the first transmit failure indication based on whether the second transmit failure indication is detected by determining, in response to not receiving the second transmit failure indication, that the cause is at least one of and active-side transmitter failure and an active-side transmit cable failure.

49. The system of claim 46 wherein the protection controller comprises logic configured to determine a cause of the first transmit failure indication based on whether the second transmit failure indication is detected by determining, in response to receiving the second transmit failure indication, that the cause is at least one of a common transmit cable failure and an incorrect transmission signal receipt at the remote endpoint.

50. The system of claim 46 comprising logic configured to, in response to determining to switch the second transmitter to the active mode, display an alert indication.

51. The system of claim 46 wherein the logic configured to display an alert indication is configured to display an indication of the determined cause.

52. The system of claim 46 wherein the protection controller switches the second transmitter to an active mode based on whether the second transmitter has previously been switched to active mode.

53. The system of claim 46 wherein the protection controller sets a flag to indicate that the second transmitter has been switched to active mode.
